(19) United States
(12) Patent Application Publication
(10) Pub. No.: US 2016/0294127 A1
(43) Pub. Date: Oct. 6, 2016

(54) Electrical Cable Storage Station

(71) Applicants: Susan Mouradian, Dudley, MA (US); Gary Starks, Dudley, MA (US)

(72) Inventors: Susan Mouradian, Dudley, MA (US); Gary Starks, Dudley, MA (US)

(21) Appl. No.: 14/997,735

(22) Filed: Jan. 18, 2016

Related U.S. Application Data
(60) Provisional application No. 62/141,934, filed on Apr. 2, 2015.

(51) Int. Cl. H01R 13/72; H01R 25/00

(52) U.S. Cl. CPC H01R 13/72; H01R 25/006

(57) ABSTRACT

An electrical cable storage station adapted to receive and stow a variety of electrical cables for various electronic devices and appliances. The storage station provides a housing having a plurality of slotted receptacles adapted to receive a connector plug having two and/or three connection prongs thereon and a plurality of ports, such as Universal Serial Bus (USB) ports, adapted to receive various other connectors. The storage station further includes a mounting bracket configured for hanging the device on a support surface in a vertical or horizontal orientation and one or more cord holders for suspending and organizing electrical cable cords thereon.

### CROSS REFERENCE TO RELATED APPLICATIONS

This application claims the benefit of U.S. Provisional Application No. 62/141,934 filed on Apr. 2, 2015. The above identified patent application is herein incorporated by reference in its entirety to provide continuity of disclosure.

### BACKGROUND OF THE INVENTION

The present invention relates to electronic storage devices. More specifically, the present invention relates to an electrical cable storage device that is configured to be mounted on a wall and is adapted to receive various electrical cable connectors therein for containing various electronic cables thereon.

Currently, individuals are unable to conveniently store multiple electrical cables, such as a chargers, extension cords, adapters, and the like, at once in one convenient device that is organized and easily accessible. Typically, individuals store their electrical cables in cluttered areas or scattered throughout their homes or offices in random locations such as baskets, cabinets, drawers, and closets. Storing them in such a manner may lead to misplaced cables, leading a user to believe a cable is lost. Further, storing them in this manner typically makes the cables get tangled and twisted, creating the user an inconvenience when trying to utilize the cables for charging a device or creating a connection between electrical devices.

To avoid misplacement or tangling of electrical cables some individuals may just try to store them by simply leaving them on tabletops or by leaving them plugged into a conventional wall outlet after use. However, this can create a messy and unorganized look and outlets are usually limited in number, thus limiting how many electrical cables one can store thereon. Further, the majority of individuals like to unplug their cables from outlets to conserve energy and prevent children or animals from accessing them. Therefore, there is a need for a storage station having a plurality of receptacles and ports adapted to receive and hold various connectors of electrical cables thereon that is further adapted to be conveniently mounted on a wall creating an area for storing and organizing the electrical cables.

### SUMMARY OF THE INVENTION

In view of the foregoing disadvantages inherent in the known types of storage devices now present in the prior art, the present invention provides an electrical cable storage station wherein the same can be utilized for providing convenience for a user when storing a variety of different electrical cables at the same time in one location to keep organized. The electrical cable storage station includes a housing having a plurality of slotted receptacles and ports thereon. The slotted receptacles are adapted to receive connector plugs having three or two pronged connections and the ports are adapted to receive various other connectors, such as Universal Serial Bus (USB), Ethernet, High-Definition Multimedia Interface (HDMI), Video Graphics Array (VGA), and coax connectors. The housing further includes one or more cord holders for removably receiving the cord of an electrical cable and a mounting bracket adapted to removably receive a hook or fastener for mounting the housing on a wall or flat surface.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the electrical cable storage station according to one embodiment of the present invention.

FIG. 2 shows a rear perspective view of the electrical cable storage station according to one embodiment of the present invention.

### DETAILED DESCRIPTION OF THE INVENTION

Reference is made herein to the attached drawings. Like reference numerals are used throughout the drawings to depict like or similar elements of the electronic device connector storage station. For the purposes of presenting a brief and clear description of the present invention, the preferred embodiment will be discussed as used for storing and organizing a plurality of electrical cables thereon. The figures are intended for representative purposes only and should not be considered to be limiting in any respect.

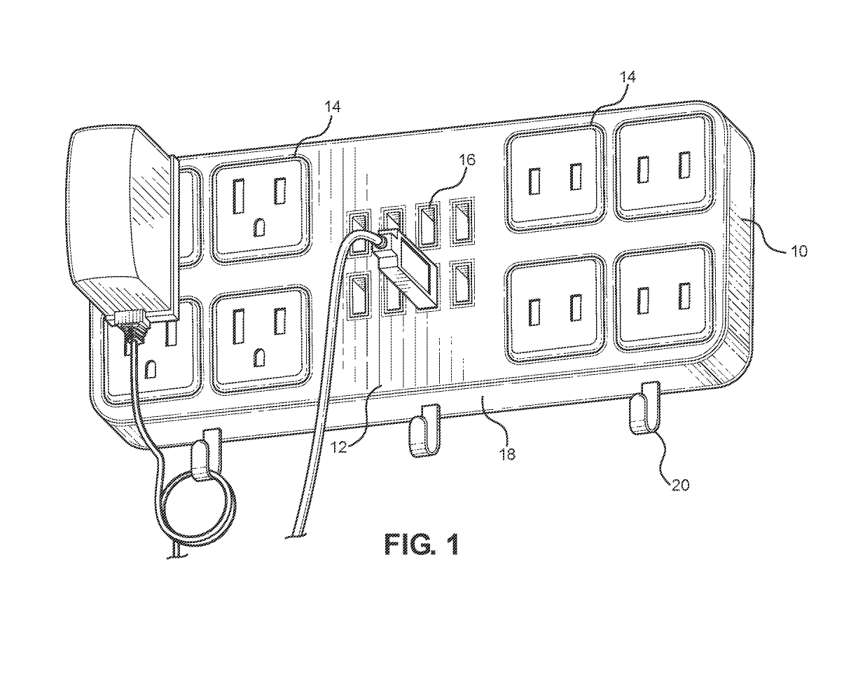

Referring now to FIG. 1, there is shown a perspective view of the electrical cable storage station according to one embodiment of the present invention. The present invention provides a storage station having a plurality of receptacles and ports adapted to receive electrical cables, such as chargers, extension cords, computer cables, adapters, USBs, and the like, for stowing and keeping same organized. The electrical cable storage station comprises a housing 10 having a substantially rectangular shape, wherein the housing 10 comprises a front side 12 and a rear side. In alternative embodiments, the housing 10 may have a circular, triangular, or elliptical shape, among others.

The front side 12 of the housing 10 comprises a plurality of slotted receptacles 14 adapted to receive connectors on electrical cables having connector plugs having two and/or three connection prongs thereon. Preferably, the housing 10 includes one or more slotted receptacles adapted to receive two pronged connector plugs and one or more slotted receptacles adapted to receive three pronged connector plugs. Each slotted receptacle 14 is adapted to secure the connector plug therein and the receptacles do not provide electricity. The slotted receptacles 14 are preferably arranged linearly in one or more rows.

The front side 12 of the housing 10 further comprises a plurality of ports thereon. Preferably, the ports are Universal Serial Bus (USB) ports 16 adapted to receive electrical cables having USB connectors. However, in alternative embodiments, the ports are also adapted to receive electrical cables having Ethernet, High-Definition Multimedia Interface (HDMI), Video Graphics Array (VGA), and coax connectors. The USB ports 16 comprise slots having an interior volume adapted to receive the female and/or male connectors of USB electrical cables. The USB ports 16 do not include a power source for providing an electrical connection to the electrical cables plugged therein. As illustrated by the depicted embodiment, the slotted receptacles 14 and the USB ports 16 are for receiving the electrical cable connectors therein for when a user wishes to stow his or her electrical cables when not in use. Preferably, similar receptacles and ports are grouped together, thereby enabling users to organize their electrical cables according to the type of connector thereon, such that electrical cables having pronged connectors are stowed in the same area and electrical cables having USB connectors are stowed in the same area.

The housing 10 further comprises a lower end 18 having one or more cord holders 20 for suspending the cords of electrical cables when they are stowed on the storage station. In the depicted embodiment, the storage station comprises three hook-like cord holders 20 adapted to removably receive the cord of an electrical cable. Preferably, each cord holder corresponds to a group of similar slotted receptacles and ports, such that each group includes its own cord holder for suspending the electrical cables stowed thereon. In one use, a user may wind the cord of his electrical cable into a circular orientation, attach the connector plug of the cable to a slotted receptacle 14, and then suspend the cord on the corresponding hook, such that it remains organized thereon as opposed to loosely dangling from the storage station.

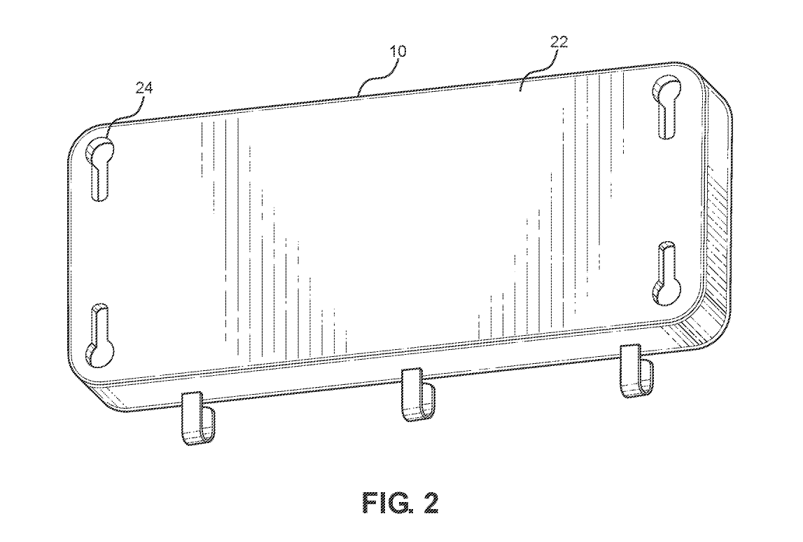

Referring now to FIG. 2, there is shown a rear perspective view of the electrical cable storage station of the present invention. The rear side 22 of the housing 10 comprises a mounting bracket 24 adapted for mounting the electrical cable storage station onto a support surface, such as a wall or other similar flat surface. The mounting bracket 24 comprises opposing apertures disposed on the surface of the rear side 22 of the housing 10. In the depicted embodiment, the mounting bracket 24 comprises two sets of opposing apertures located at the top left and top right corners and bottom left and bottom right corners of the rear side 22 of the housing 10. The apertures are adapted to removably receive a hook or a fastener, such as a screw, bolt, and/or nail, such that a user may hang the housing 10 on the hook or fastener, when attached to a wall, in either a horizontal or vertical orientation. In another embodiment, the mounting bracket 24 comprises one set of opposing apertures located on the left and right side the rear side 22 of the housing 10. In other embodiments, the mounting bracket 24 comprises a recessed groove and/or opening adapted to receive a hook or fastener. In another embodiment, the mounting bracket 24 comprises a wire or cable adapted to receive a hook or fastener. In yet another embodiment, the mounting bracket 24 comprises an adhesive adapted to attach to a support surface, such as a wall or other similar flat surface.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An electrical cable storage station, comprising:
a housing having a front side and a rear side;
a plurality of slotted receptacles disposed on the front side of the housing, wherein the slotted receptacles are adapted to removably receive electrical connectors;
a plurality of ports disposed on the front side of the housing, wherein the ports are adapted to removably receive electrical connectors; and
one or more cord holders extending from the housing, wherein the one or more cord holders are adapted to removably receive the cord of an electrical cable.

2) The electrical cable storage station of claim 1, further comprising a mounting bracket disposed on the rear side of the housing, wherein the mounting bracket is adapted to removably receive a hook or fastener.

3) The electrical cable storage station of claim 1, wherein the housing is rectangular in shape.

4) The electrical cable storage station of claim 1, wherein the plurality of slotted receptacles are adapted to receive electrical connectors having three-pronged connection plugs.

5) The electrical cable storage station of claim 1, wherein the plurality of slotted receptacles are adapted to receive electrical connectors having two-pronged connection plugs.

6) The electrical cable storage station of claim 1, wherein the plurality of ports are adapted to receive USB electrical connectors.

7) The electrical cable storage station of claim 1, wherein the housing comprises four slotted receptacles adapted to receive electrical connectors having three-pronged connection plugs.

8) The electrical cable storage station of claim 1, wherein the housing comprises eight ports adapted to receive Universal Serial Bus connectors.

9) The electrical cable storage station of claim 1, wherein the housing comprises four slotted receptacles adapted to receive electrical connectors having two-pronged connection plugs.

10) The electrical cable storage station of claim 1, wherein the one or more cord holders comprise hooks.

11) The electrical cable storage station of claim 2, wherein the mounting bracket comprises opposing apertures disposed on a left side and a right side of the rear side of the housing.
